(19) United States
(12) Patent Application Publication
(10) Pub. No.: US 2009/0171763 A1
(43) Pub. Date: Jul. 2, 2009

(54) System and method for online advertising driven by predicting user interest

(75) Inventors: Jessi Dong, Saratoga, CA (US); Wei Du, Burbank, CA (US); Sam P. Hamilton, Los Altos, CA (US); Michael Helman, Oakland, CA (US); Aparna Seetharaman, Palo Alto, CA (US); Yang Wang, Union City, CA (US)

Correspondence Address: Law Office of Robert O. Bolan, P.O. Box 36, Bellevue, WA, 98009, US

(73) Assignee: Yahoo! Inc., Sunnyvale, CA (US)

(21) Appl. No.: 12/006,179

(22) Filed: Dec. 31, 2007

(51) Int. Cl. G06Q 30/00

(52) U.S. Cl. 705/10; 705/14

(57) ABSTRACT

An improved system and method for online advertising driven by predicting user interest is provided. An advertising demand engine may be provided for selecting advertisements to be served to a user for display with requested content. An advertisement may be correlated to an advertisement previously selected by a user or by other users in the user's segment. An advertising correlation engine may be provided for correlating an advertisement to another advertisement using collaborative filtering, an advertising clustering engine may be provided for clustering correlated advertisements using item-based collaborative filtering, and a user correlation engine may be provided for segmenting users by selected advertisements and creating a cluster of advertisements associated with each cluster of users. Correlated advertisements that are selected may be allocated web page placements and then served to a user for display with requested content.

### FIELD OF THE INVENTION

The invention relates generally to computer systems, and more particularly to an improved system and method for online advertising driven by predicting user interest.

### BACKGROUND OF THE INVENTION

Traditionally, there are two internet advertising market segments. One is text advertisement segment, and the other is banner segment. Text advertisements business is mainly conducted through sponsored search auction and content match technologies. Sponsored search auctions are a widely used mechanism for selling online advertisements using Internet search engines. Each time a user enters a search term into a search engine, a sponsored search auction allocates the advertising space within that user's search results. There are hundreds of millions of separate online sponsored search auctions conducted every day. Content matching is also a widely used mechanism for selling online advertising by matching advertisements to content published on the Internet. Each time a user requests published content, advertising space may be allocated within the content served in response to the user's request.

For instance, in online search advertising, keywords of a user's query may be auctioned to an advertiser who is the highest bidder with sufficient budget. In content matching, page content may be aggregated into keywords, and advertisements may be match to content using the highest payment offered by an advertiser for the keywords representing the content.

For banner advertising segment, behavioral targeting technology has been used, where both users and advertisements are mapped into categories, and then advertisements that are in the same categories with a user will be served to that user. Unfortunately, the categories may be defined by marketing personnel relying on their experience, rather than by the interests of the users. Moreover, the categories may be defined in a hierarchy that may focus on vertical areas such as travel or shopping, and thus may unnecessarily restrict selection of an advertisement within a vertical, instead of considering the broader interests of the users.

What is needed is a way to provide advertisements that are more relevant to users' interest. Such a system and method should consider users' experience and interests to provide more relevant advertisements.

### SUMMARY OF THE INVENTION

The present invention provides a system and method for online advertising driven by predicting user interest via analyzing the correlation among advertisements and users. An advertising demand engine may be provided for selecting advertisements to be served to a user for display with requested content. In general, an advertisement may be correlated to an advertisement previously selected by a user or by other users in a segment including the user. An advertisement correlation engine may be provided for correlating one advertisement to another advertisement or clustering correlated advertisements using item-based collaborative filtering, and a user correlation engine may be provided for correlating one user to another or segmenting users. One or more advertisements may be selected for display to a user that are correlated with one or more advertisements previously selected by the user, or selected by others who are in same user cluster as the user.

To correlate an advertisement to another advertisement in order to predict user interest, a list of links to advertisements selected by each user in a group of users may be received, and collaborative filtering may be used in an embodiment to correlate each advertisement with another advertisement from the advertisements selected by the group of users. A list of links to advertisements selected by each user in a group of users may also be clustered in another embodiment using item-based collaborative filtering to correlate each advertisement previously selected by a user with other advertisements from the advertisements selected by the group of users. To correlate a user to another user in order to predict user interest, a list of links to advertisements selected by each user in a group of users may be received, and collaborative filtering may be used in an embodiment to correlate each user with another user from the advertisements selected by the group of users. In yet another embodiment, a list of links to advertisements selected by each user in a group of users may be received, and the group of users may be clustered into segments by the links to advertisements selected by each of the users. Such a segmentation of a group of users may additionally create a cluster of advertisements for each cluster of users.

The present invention may support many applications for online advertising driven by predicting user interest. For example, online search advertising applications may use the present invention to select a list of advertisements predicted to be of user interest for web page placements displayed with query results for a user. Or online content applications may use the present invention to select a list of advertisements predicted to be of user interest for web page placements displayed with content requested by a user. Similarly, email applications may use the present invention to select a list of advertisements predicted to be of user interest to be displayed with a message from an inbox requested by a user, or ecommerce applications may use the present invention to select a list of advertisements predicted to be of user interest to be displayed with product information requested by a user. For any of these online applications, a list of advertisements predicted to be of user interest may be selected by the present invention for display to a user.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for online advertising driven by predicting user interest, in accordance with an aspect of the present invention;

FIG. 3 is a flowchart generally representing the steps undertaken in one embodiment for online advertising driven by predicting user interest, in accordance with an aspect of the present invention;

FIG. 4 is a flowchart generally representing the steps undertaken in one embodiment to correlate an advertisement with another advertisement for online advertising driven by predicting user interest, in accordance with an aspect of the present invention;

FIG. 5 is a flowchart generally representing the steps undertaken in one embodiment to cluster advertisements with correlated advertisements previously selected by a user for online advertising driven by predicting user interest, in accordance with an aspect of the present invention;

FIG. 6 is a flowchart generally representing the steps undertaken in one embodiment to correlate a user with another user for online advertising driven by predicting user interest, in accordance with an aspect of the present invention; and

FIG. 7 is a flowchart generally representing the steps undertaken in one embodiment for clustering a group of users by selected advertisements to create segments of users to serve advertisements for online advertising driven by predicting user interest, in accordance with an aspect of the present invention.

### DETAILED DESCRIPTION

### Exemplary Operating Environment

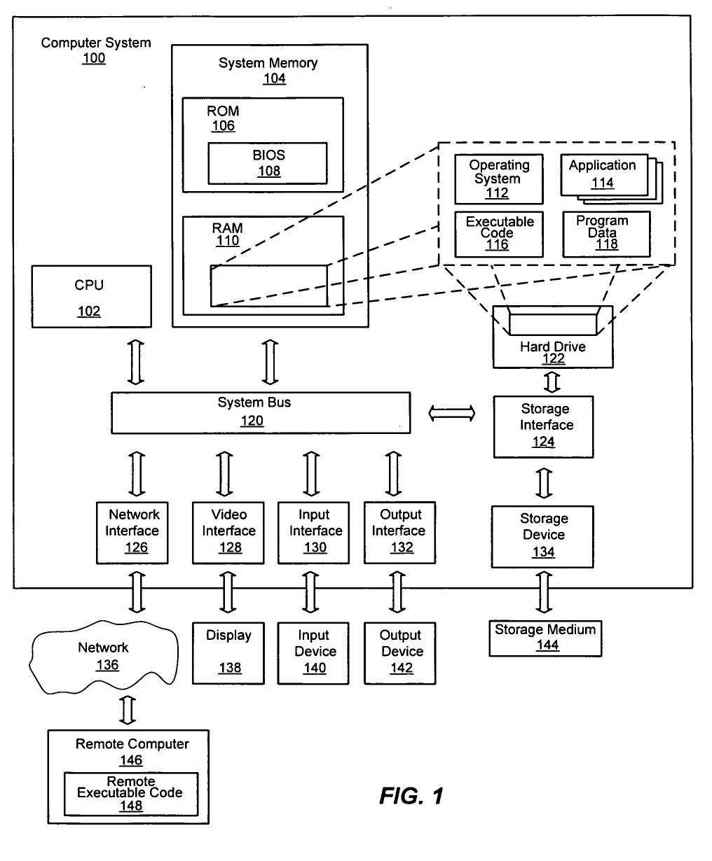

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Online Advertising Driven by Predicting User Interest

The present invention is generally directed towards a system and method for online advertising driven by predicting user interest. In general, an advertisement may be correlated to one or more advertisements previously selected by a user or by other users in order to predict advertisements of interest to the user. An advertisement may be correlated to another advertisement using collaborative filtering. Additionally, an advertisement may be correlated to a group of advertisements using item-based collaborative filtering or using segmentation to cluster users by selected advertisements and thereby create a cluster of advertisements associated with each cluster of users. One or more advertisements may then be selected for display to a user that are correlated with an advertisement previously selected by the user. The list of advertisements may be allocated to web page placements and served to the user for display in the online advertising. As used herein, a web page placement may mean a location on a web page designated for placing an advertisement for display.

As will be seen, the present invention may support many applications for online advertising driven by predicting user interest. For example, online search advertising applications may use the present invention to select a list of advertisements predicted to be of user interest for web page placements displayed with query results for a user. Or online content applications may use the present invention to select a list of advertisements predicted to be of user interest for web page placements displayed with content requested by a user. As will be understood, the various block diagrams, flow charts and scenarios described herein are only examples, and there are many other scenarios to which the present invention will apply.

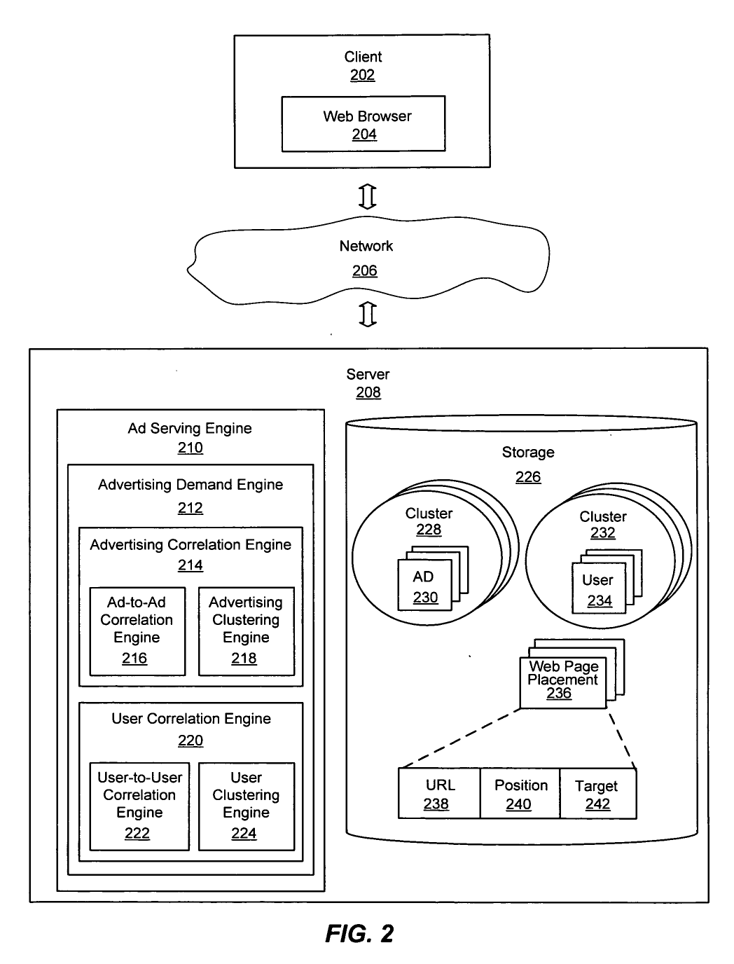

Turning to FIG. 2 of the drawings, there is shown a block diagram generally representing an exemplary architecture of system components for online advertising driven by predicting user interest. Those skilled in the art will appreciate that the functionality implemented within the blocks illustrated in the diagram may be implemented as separate components or the functionality of several or all of the blocks may be implemented within a single component. For example, the functionality for the advertising correlation engine 214 may be included in the same component as the advertising demand engine 212. Or the functionality of the advertisement demand engine 212 may be implemented as a separate component from the advertisement serving engine 210. Moreover, those skilled in the art will appreciate that the functionality implemented within the blocks illustrated in the diagram may be executed on a single computer or distributed across a plurality of computers for execution.

In various embodiments, a client computer 202 may be operably coupled to one or more servers 208 by a network 206. The client computer 202 may be a computer such as computer system 100 of FIG. 1. The network 206 may be any type of network such as a local area network (LAN), a wide area network (WAN), or other type of network. A web browser 204 may execute on the client computer 202 and may include functionality for receiving a request for content which may be input by a user and for sending the request to a server to obtain the requested content. In general, the web browser 204 may be any type of interpreted or executable software code such as a kernel component, an application program, a script, a linked library, an object with methods, and so forth. In various embodiments, other applications may be used for sending a request for content, including an email application requesting a message from an inbox, an ecommerce application requesting product information, and an online search advertising application requesting search results for a query, and so forth.

The server 208 may be any type of computer system or computing device such as computer system 100 of FIG. 1. In general, the server 208 may provide services for processing requests for content and may include services for providing a list of advertisements to accompany the content requested. In particular, the server 208 may include an advertisement serving engine 210 for serving advertisements, an advertising demand engine 212 for providing a list of one or more advertisements to accompany requested content, an advertising correlation engine 214 for correlating advertisements, and a user correlation engine 220 for correlating users by selected advertisements. The advertising correlation engine 214 may include an ad-to-ad correlation engine for correlating an advertisement to another advertisement and an advertising clustering engine 218 for clustering advertisements. The user correlation engine 220 may include a user-to-user correlation engine 222 for correlating a user to another user by selected advertisements and a user clustering engine 224 for segmenting users by selected advertisements. Each of these modules may also be any type of executable software code such as a kernel component, an application program, a linked library, an object with methods, or other type of executable software code.

The server 208 may be operably coupled to a database of information such as storage 226 that may include clusters 228 of any type of advertisements 230 and clusters 232 of users 234. In an embodiment, an advertisement 230 may be displayed according to a web page placement 236. The web page placement 236 may include a Uniform Resource Locator (URL) 238 for a web page, a position 240 for displaying an advertisement on the web page, and a target ID 242 for referencing a target or group of visitors that may be defined by a profile of characteristics that may match a visitor of the web page. In various embodiments, a target may be defined by demographic information including gender, age, or surfing behavior. The segmentation of grouping users by selected advertisements may co-exist with existing segmentation methods including demographic-based in various embodiments.

There may be many applications which may use the present invention for online advertising driven by predicting user interest. For example, online search advertising applications may use the present invention to select a list of advertisements predicted to be of user interest for web page placements displayed with query results for a user. Or online content applications may use the present invention to select a list of advertisements predicted to be of user interest for web page placements displayed with content requested by a user. Similarly, email applications may use the present invention to select a list of advertisements predicted to be of user interest to be displayed with a message from an inbox requested by a user, or ecommerce applications may use the present invention to select a list of advertisements predicted to be of user interest to be displayed with product information requested by a user. For any of these online applications, a list of advertisements predicted to be of user interest may be selected by the present invention for display to a user.

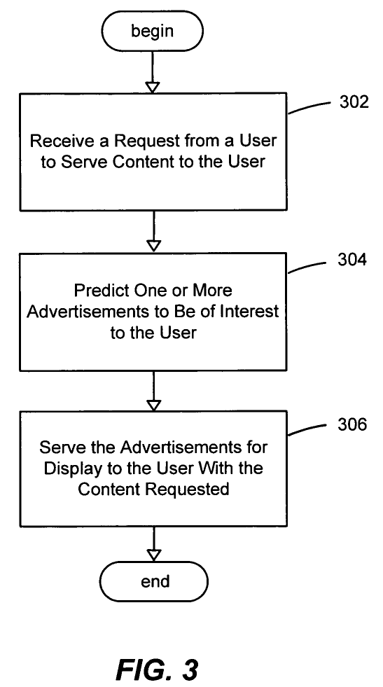

FIG. 3 presents a flowchart for generally representing the steps undertaken in one embodiment for online advertising driven by predicting user interest. At step 302, a request to serve content may be received from a user. For example, a user may click a link in an embodiment to request content of a web page to be served to the user's web browser. At step 304, one or more advertisements may be predicted to be of interest to the user. In an embodiment, one or more advertisements may be predicted by correlating each advertisement in a group of advertisements to another advertisement. In another embodiment, one or more advertisements may be predicted by clustering correlated advertisements previously selected by the user. In yet another embodiment, one or more advertisements may be predicted by segmenting users by selected advertisements, and then selecting an advertisement in the user's segment that may not be previously displayed to the user.

Once one or more advertisements may be predicted to be of interest to the user, the advertisements may be served at step 306 to a user for display to the user with the content requested. In an embodiment, there may be an advertisement in the list of advertisements served for each web page placement available for display with the requested content. In various embodiments, the user click session may be tracked at runtime and advertisements may be correlated in real-time. In various other embodiments, a history of user clicks selecting advertisements may be analyzed off-line and advertisements may be correlated off-line.

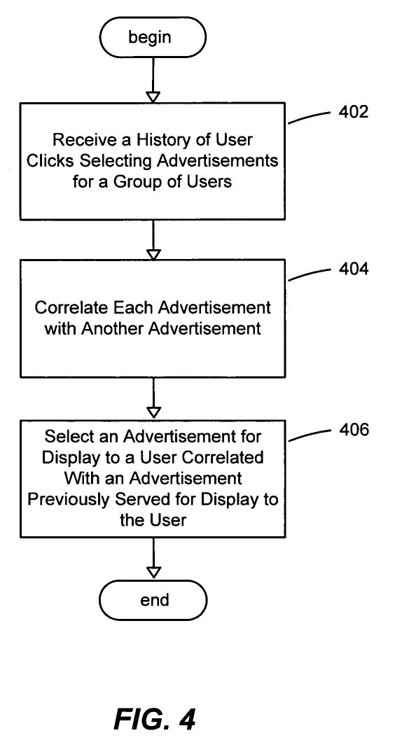

FIG. 4 presents a flowchart for generally representing the steps undertaken in one embodiment to correlate an advertisement with another advertisement for online advertising driven by predicting user interest. At step 402, a history of user clicks selecting advertisements may be received for a group of users. For example, a list of links to advertisements selected by a user may be received for each user in the group of users in an embodiment. At step 404, each advertisement may be correlated with another advertisement from the advertisements selected by the group of users. In an embodiment, collaborative filtering may be used to correlate each advertisement with another advertisement from the advertisements selected by the group of users.

Once each advertisement may be correlated with another advertisement, an advertisement correlated to an advertisement previously served for display to a user may be selected at step 406 for display to the user. In an embodiment, a most recent link to an advertisement in a user's click history may be used to select a correlated advertisement for display to the user.

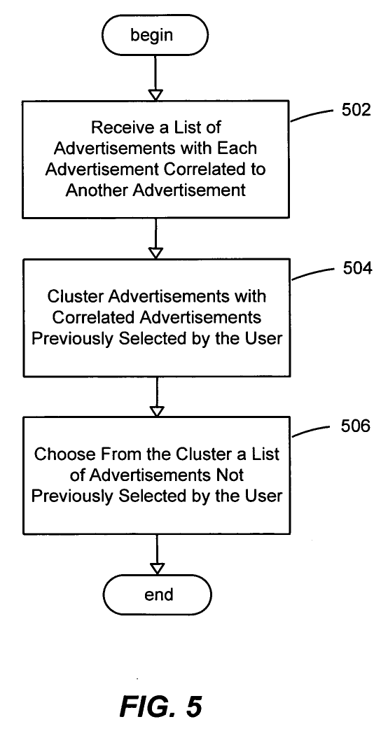

FIG. 5 presents a flowchart for generally representing the steps undertaken in one embodiment to cluster advertisements with correlated advertisements previously selected by a user for online advertising driven by predicting user interest. At step 502, a list of advertisements may be received for a group of users with each advertisement correlated to another advertisement in the list. In an embodiment, the list of advertisement may be correlated with another advertisement in the list by employing the steps discussed above in conjunction with FIG. 4. At step 504, each advertisement previously selected by a user in the list of advertisements may be clustered with other advertisements correlated in the list of advertisements selected by the group of users. In an embodiment, item-based collaborative filtering may be used to correlate each advertisement previously selected by a user with other advertisements from the advertisements selected by the group of users. Thus, when a user has clicked several advertisements that fall within a cluster, then other advertisements within the cluster may be displayed to the user.

Once each advertisement previously selected by a user may be correlated with other advertisement from the advertisements selected by the group of users, a list of advertisements not previously selected by a user may be chosen from the cluster of advertisements to serve for display to a user at step 506. In an embodiment, a most recent link to an advertisement in a user's click history may be used to select a list of advertisements from the cluster of advertisements for display to the user.

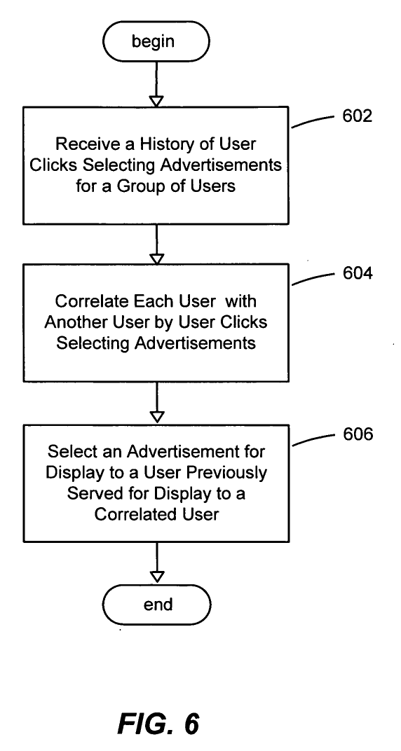

FIG. 6 presents a flowchart for generally representing the steps undertaken in one embodiment to correlate a user with another user for online advertising driven by predicting user interest. At step 6.02, a history of user clicks selecting advertisements may be received for a group of users. For example, a list of links to advertisements selected by a user may be received for each user in the group of users in an embodiment. At step 604, each user may be correlated with another user from the advertisements selected by the group of users. In an embodiment, collaborative filtering may be used to correlate each user with another user from the advertisements selected by the group of users.

Once each user may be correlated with another user, an advertisement may be selected at step 606 for display to a user that was previously served for display to a correlated user. In an embodiment, a most recent link to an advertisement in a correlated user's click history may be used to select an advertisement for display to the user.

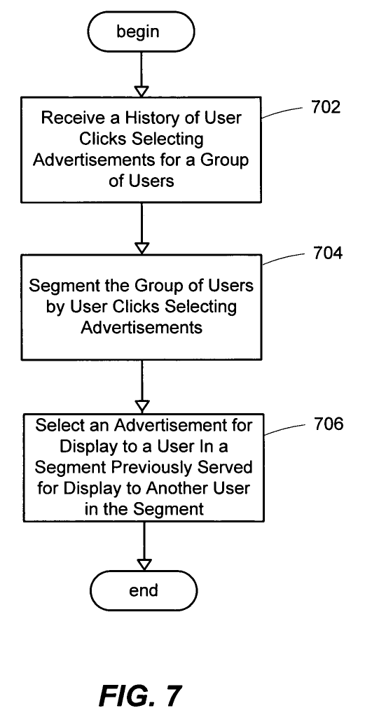

FIG. 7 presents a flowchart generally representing the steps undertaken in one embodiment for clustering a group of users by selected advertisements to create segments of users to serve advertisements not previously displayed to a user for online advertising driven by predicting user interest. At step 702, a history of user clicks selecting advertisements may be received for a group of users. For example, a list of links to advertisements selected by a user may be received for each user in the group of users in an embodiment. At step 704, the group of users may be clustered into segments by the links to advertisements selected by each of the users. In an embodiment, the top K users may be picked for a cluster from a ranking of correlation scores generated by correlating a user to a user by links to advertisements selected by each of the users. Note that the segmentation may create a cluster of advertisements for each cluster of users. This cluster of advertisements may include the advertisements selected by each of the users in the cluster and may also include advertisements correlated to the advertisements selected by each of the users in the cluster.

At step 706, a list of advertisements not previously selected by a user may be chosen from the cluster of advertisements in the user's segment to serve for display to a user. Since an advertisement clicked by a user in a group of users that have similar interests is likely to be clicked by other users in the group, a user may be served advertisements predicted to be of interest to the user.

Those skilled in the art will appreciate that the present invention may correlate advertisements and users by an indication of a user's interest in an advertisement other than by the user selecting a link to an advertisement. For instance, in addition to showing interest in an advertisement by selecting a link to an advertisement, a user may mouse over a link to an advertisement or a graphical advertisement to indicate interest. Or conversion rates of impressions of an advertisement may be used. Moreover, different indications of user interest may be combined to generate a user interest score. Such a score could further be weighted by other factors such as revenue potential, delivery objectives, and so forth.

Thus the present invention may serve advertisements predicted to be of interest to users. By providing more relevant advertisements to users, the click-through rates of advertisements served to users may increase, and in turn, revenue from online advertising may also enjoy a concomitant increase. Advantageously, the system and method is able to respond to changing user interest in online advertising by tracking user click history and updating the correlation between advertisements, updating user segments and advertisement clusters associated with user segments. Analysis of a user's web browser history may further be used to update user segments. In addition to increasing revenue, serving advertisement of interest to users may also improve the user experience in many online advertising applications. Importantly, the system and method scale well for different types of rich media advertisements, including video advertisements, Internet TV, music advertisements, graphics advertisements, and text advertisements.

As can be seen from the foregoing detailed description, the present invention provides an improved system and method for online advertising driven by predicting user interest. An advertising demand engine may be provided for selecting correlated advertisements to be served to a user for display with requested content. An advertisement may be correlated to an advertisement previously selected by a user or by other users. Correlated advertisements that are selected may be allocated web page placements and then served to a user for display with requested content. Many applications may use the present invention for online advertising driven by predicting user interest, including online search advertising applications to select a list of advertisements predicted to be of user interest for web page placements displayed with query results for a user, or online content applications to select a list of advertisements predicted to be of user interest for web page placements displayed with content requested by a user. As a result, the system and method provide significant advantages and benefits needed in contemporary computing, and more particularly in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for online advertising, comprising:
an advertising demand engine for selecting one or more advertisements predicted to be of interest to a user based on a correlation with a previously served advertisement for display to the user; and
a storage operably coupled to the advertising demand engine for storing a plurality of advertisements predicted to be of interest to a user based on a correlation with a plurality of previously served advertisements.

2. The system of claim 1 further comprising an advertising correlation engine operably coupled to the advertising demand engine for correlating an advertisement with a previously served advertisement for display to the user.

3. The system of claim 1 further comprising an advertising clustering engine operably coupled to the advertising demand engine for clustering a plurality of correlated advertisements.

4. The system of claim 1 further comprising a user clustering engine for segmenting a plurality of users by a plurality of selected advertisements into a plurality of segments to serve one or more advertisements not previously displayed to the user from the user's segment to the user for display in online advertising.

5. A computer-readable medium having computer-executable components comprising the system of claim 1.

6. A computer-implemented method for online advertising, comprising:
receiving a request from a user to serve online content to the user;
selecting at least one advertisement predicted to be of interest to the user based on a correlation with at least one previously served advertisement for display to the user in online advertising;
allocating the at least one advertisement to at least one web page placement for display to the user; and
outputting the at least one advertisement for display to the user with the requested content.

7. The method of claim 6 further comprising correlating the at least one advertisement with the at least one previously served advertisement for display to the user.

8. The method of claim 7 wherein correlating the at least one advertisement with the at least one previously served advertisement for display to the user comprises using collaborative filtering on a plurality of advertisements selected by a plurality of users to correlate the at least one advertisement with the at least one previously served advertisement for display to the user.

9. The method of claim 6 wherein selecting at least one advertisement predicted to be of interest to the user based on a correlation with at least one previously served advertisement for display to the user in online advertising comprises selecting the at least one advertisement predicted to be of interest to the user identified by collaborative filtering on a plurality of advertisements selected by a plurality of users.

10. The method of claim 6 further comprising clustering a plurality of advertisements correlated with the at least one previously served advertisement for display to the user.

11. The method of claim 10 wherein clustering a plurality of advertisements correlated with the at least one previously served advertisement for display to the user comprises using item-based collaborative filtering to correlate a plurality of advertisements previously selected by a user with a plurality of advertisements selected by a group of users.

12. The method of claim 6 wherein selecting at least one advertisement predicted to be of interest to the user based on a correlation with at least one previously served advertisement for display to the user in online advertising comprises selecting the at least one advertisement predicted to be of interest to the user identified by item-based collaborative filtering on a plurality of advertisements selected by a plurality of users.

13. The method of claim 6 further comprising segmenting a plurality of users into a plurality of clusters of users by a plurality of advertisements previously served for display to the plurality of users in online advertising.

14. The method of claim 13 wherein segmenting the plurality of users into the plurality of clusters of users by the plurality of advertisements previously served for display to the plurality of users in online advertising comprises creating a cluster of a plurality of advertisements for each cluster of users.

15. The method of claim 6 wherein selecting at least one advertisement predicted to be of interest to the user based on a correlation with at least one previously served advertisement for display to the user in online advertising comprises selecting the at least one advertisement predicted to be of interest to the user from a cluster of advertisements associated with a segment of the user.

16. The method of claim 6 wherein outputting the at least one advertisement for display to the user with the requested content comprises sending the at least one advertisement allocated at least one web page placement to a client device for display.

17. A computer-readable medium having computer-executable instructions for performing the method of claim 6.

18. A computer system for online advertising, comprising:
means for selecting at least one advertisement predicted to be of interest to a user based on a correlation with at least one previously served advertisement for display to the user in online advertising;
means for allocating the at least one advertisement to at least one web page placement for display to the user; and
means for outputting the at least one advertisement for display to the user.

19. The computer system of claim 18 further comprising means for correlating the at least one advertisement with the at least one previously served advertisement for display to the user.

20. The computer system of claim 18 further comprising means for segmenting a plurality of users by a plurality of advertisements selected in online advertising.
